(19) United States
(12) Patent Application Publication
(10) Pub. No.: US 2024/0284229 A1
(43) Pub. Date: Aug. 22, 2024

(54) SENSING SIGNAL PROCESSING METHOD AND APPARATUS AND COMMUNICATION DEVICE

(71) Applicant: VIVO MOBILE COMMUNICATION CO., LTD., Dongguan (CN)

(72) Inventors: Jian YAO, Dongguan (CN); Dajie JIANG, Dongguan (CN); Shengli DING, Dongguan (CN); Baolong CHEN, Dongguan (CN); Pucong WANG, Dongguan (CN)

(73) Assignee: VIVO MOBILE COMMUNICATION CO., LTD., Dongguan (CN)

(21) Appl. No.: 18/646,752

(22) Filed: Apr. 25, 2024

Related U.S. Application Data
(63) Continuation of application No. PCT/CN2022/126665, filed on Oct. 21, 2022.

(30) Foreign Application Priority Data
Oct. 27, 2021 (CN) 202111258041.7

(51) Int. Cl. H04W 24/10; H04B 17/309; H04B 17/318; H04W 72/044

(52) U.S. Cl. CPC H04W 24/10; H04B 17/328; H04B 17/346; H04W 72/044

(57) ABSTRACT

This application discloses a sensing signal processing method and apparatus and a communication device. The method includes: reporting, by a first device, a first sensing measurement result and first information to a second device, where the first information includes at least one of the following: a first sensing indicator, where the first sensing indicator is a sensing indicator associated with the first sensing measurement result; or first sensing resource indication information, where the first sensing resource indication information is used to indicate resource information corresponding to the first sensing measurement result.

### CROSS-REFERENCE TO RELATED APPLICATIONS

This application is a continuation of International Application No. PCT/CN2022/126665, filed Oct. 21, 2022, which claims priority to Chinese Patent Application No. 202111258041.7, filed Oct. 27, 2021. The entire contents of each of the above-referenced applications are expressly incorporated herein by reference.

### TECHNICAL FIELD

The present application relates to the field of communication technologies, and in particular, to a sensing signal processing method and apparatus, and a communication device.

### BACKGROUND

In addition to having a communication capability, a future mobile communication system further has a sensing capability. The sensing capability is that one or more devices with the sensing capability can sense information such as a direction, a distance, and a speed of a target object by sending and receiving a wireless signal, or detect, track, identify, and image a target object, an event, an environment, and the like. A communication system performs a measurement process to assist in improving communication performance, and a sensing system performs a measurement process to obtain an ideal sensing result based on a sensing measurement result. Therefore, sensing measurement needs to aim to improve sensing performance. However, in a related technology, there is no related solution to improve sensing performance.

### SUMMARY

Embodiments of this application provide a sensing signal processing method and apparatus and a communication device.

According to a first aspect, a sensing information processing method is provided, and includes:
reporting, by a first device, a first sensing measurement result and first information to a second device; where
the first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

According to a second aspect, a sensing information processing method is provided, and includes:
receiving, by a second device, a first sensing measurement result and first information that are reported by a first device; and
adjusting, by the second device, configuration information of a sensing signal based on the first sensing measurement result and the first information, where the configuration information includes resource information of the sensing signal; and
the first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

According to a third aspect, a sensing information processing apparatus is provided, and includes
a first reporting module, configured to report a first sensing measurement result and first information to a second device; where
the first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

According to a fourth aspect, a sensing information processing apparatus is provided, and includes:
a first receiving module, configured to receive a first sensing measurement result and first information that are reported by a first device; and
a first adjustment module, configured to adjust configuration information of a sensing signal based on the first sensing measurement result and the first information, where
the configuration information includes resource information of the sensing signal; and
the first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

According to a fifth aspect, a communication device is provided. The communication device includes a processor, a memory, and a program or an instruction that is stored in the memory and that can run on the processor, and when the program or the instruction is executed by the processor, steps of the method according to the first aspect or the second aspect are implemented.

According to a sixth aspect, a communication device is provided, including a processor and a communication interface. The communication interface is configured to report a first sensing measurement result and first information to a second device, where the first information includes at least one of the following: a first sensing indicator, where the first sensing indicator is a sensing indicator associated with the first sensing measurement result; or first sensing resource indication information, where the first sensing resource indication information is used to indicate resource information corresponding to the first sensing measurement result. In some embodiments, the communication interface is configured to receive a first sensing measurement result and first information that are reported by a first device, and the processor is configured to adjust configuration information of a sensing signal based on the first sensing measurement result and the first information, where the configuration information includes resource information of a sensing signal, and the first information includes at least one of the following: a first sensing indicator, where the first sensing indicator is a sensing indicator associated with the first sensing measurement result; or first sensing resource indication information, where the first sensing resource indication information is used to indicate resource information corresponding to the first sensing measurement result.

According to a seventh aspect, a readable storage medium is provided, where the readable storage medium stores a program or an instruction, and when the program or the instruction is executed by a processor, steps of the method according to the first aspect are implemented, or steps of the method the second aspect are implemented.

According to an eighth aspect, a chip is provided. The chip includes a processor and a communication interface, the communication interface is coupled to the processor, and the processor is configured to run a program or an instruction, to implement the method according to the first aspect or the method according to the second aspect.

According to a ninth aspect, a computer program/program product is provided, where the computer program/program product is stored in a non-volatile storage medium, and the computer program/program product is executed by at least one processor to implement steps of the method according to the first aspect or the second aspect.

In the embodiments of this application, a first device reports a first sensing measurement result and first information to a second device, where the first information includes at least one of a first sensing indicator or first sensing resource indication information, and the second device adjusts, based on at least one of the first sensing indicator or the first sensing resource indication information, resource configuration information for subsequently sending a sensing signal, so that sensing performance can be effectively improved.

### BRIEF DESCRIPTION OF DRAWINGS

FIG. 1 is a structural diagram of a communication system to which embodiments of this application can be applied;

FIG. 2 is a first flowchart of a sensing information processing method according to an embodiment of this application;

FIG. 3 is a second flowchart of a sensing information processing method according to an embodiment of this application;

FIG. 4 shows a first time domain data FFT operation result represented by an actual frequency according to this embodiment of this application;

FIG. 5 shows a first time domain data FFT operation result represented by an FFT index according to an embodiment of this application;

FIG. 6 is a schematic diagram of display of second time domain data according to an embodiment of this application;

FIG. 7 is a first diagram of modules of a sensing information processing apparatus according to an embodiment of this application;

FIG. 8 is a second diagram of modules of a sensing information processing apparatus according to an embodiment of this application;

FIG. 9 is a structural block diagram of a communication device according to an embodiment of this application;

FIG. 10 is a structural block diagram of a terminal according to an embodiment of this application; and

FIG. 11 is a structural block diagram of a network device according to an embodiment of this application.

### DETAILED DESCRIPTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a New Radio (NR) system for example purposes, and NR terms are used in most of the following descriptions, and these technologies can also be applied to an application other than an NR system application, for example, a 6^{th} generation (6G) communication system.

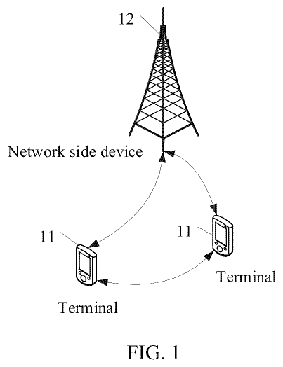

FIG. 1 is a structural diagram of a wireless communication system to which embodiments of this application can be applied. The wireless communication system includes a terminal 11 and a network side device 12. The terminal 11 may also be referred to as a terminal device or User Equipment (UE). The terminal 11 may be a mobile phone, a tablet personal computer, a laptop computer that is referred to as a notebook computer, a personal digital assistant (PDA), a palm computer, a netbook, an ultra-mobile personal computer (UMPC), a mobile Internet device (MID), an augmented reality (AR)/virtual reality (VR) device, a robot, a wearable device, in-vehicle user equipment (VUE), pedestrian user equipment (PUE), or a smart home device (a home device with a wireless communication function, such as a refrigerator, a television, a washing machine, or furniture). The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, a game console, and the like. It should be noted that a specific type of the terminal 11 is not limited in the embodiments of this application. The network side device 12 may be a base station or a core network. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmitting Receiving Point (TRP), or some other appropriate term in the art. Provided that a same technical effect is achieved, the base station is not limited to a specific technical term.

To enable a person skilled in the art to better understand the embodiments of this application, the following descriptions are provided first.

Integrated communication and sensing means that in a same system, a design of integrated communication and sensing functions is implemented through spectrum sharing and hardware sharing. When information is transmitted, the system can sense information such as a direction, a distance, and a speed, and detect, track, and identify a target device or an event. A communication system and a sensing system cooperate with each other, to improve overall performance and bring better service experience.

A future mobile communication system, such as a B5G system or a 6G system, has a sensing capability in addition to a communication capability. The sensing capability is that one or more devices with the sensing capability can sense information such as a direction, a distance, and a speed of a target object by sending and receiving a wireless signal, or detect, track, identify, and image a target object, an event, an environment, and the like. In the future, with the deployment of small base stations with a high frequency band and high bandwidth capability such as millimeter wave and terahertz in a 6G network, sensing resolution is significantly improved compared with a centimeter wave, so that the 6G network can provide a more precise sensing service.

The integration of communication and a radar is a typical application of integrated communication and sensing. In the past, a radar system and a communication system are strictly differentiated due to different research objects and concerns. In most scenarios, the two systems are separately studied. Actually, a radar and a communication system are also used as a typical manner of information sending, obtaining, processing, and switching, regardless of a working principle, a system architecture, and a frequency band. The integrated design of communication and radar is quite feasible, which is mainly embodied in the following aspects: First, both the communication system and the sensing system are based on the electromagnetic wave theory, and transmission and receiving of an electromagnetic wave are used to complete information obtaining and transmission. Second, both the communication system and the sensing system have structures such as an antenna, a transmit end, a receive end, a signal processor, and the like, and overlap to a great extent in terms of hardware resources. With the development of technologies, the communication system and the sensing system have increasingly more overlapping in terms of working frequency bands. In addition, there is similarity in key technologies such as signal modulation and reception detection and waveform design. Fusion of the communication system and the radar system can bring many advantages, such as reducing costs, reducing sizes, reducing power consumption, improving spectrum efficiency, and reducing mutual interference, thereby improving overall system performance.

Currently, there are many related research on integrated design of the radar system and the communication system. A typical joint design includes: spectrum coexistence, that is, the two systems work independently, and information exchange can be allowed to reduce mutual interference; sharing of a receive end, where in this case, transmit ends of the two systems send respective signal waveforms, and the waveforms of the two systems need to be orthogonal, thus not affecting respective receiving and detection; sharing of a transmit end, that is, the transmit end transmits a joint waveform of a radar and communication; and sharing of a transmit end and a receive end, that is, resources are shared on a transmit end and a receive end of the two systems, and similarly, a joint waveform or waveforms in an orthogonal relationship need to be used.

During sensing, sensing may be performed based on a single-station mode, that is, transmit/receive co-location. A transmit end transmits a sensing signal, and then receives an echo signal and analyzes the echo signal to extract a sensing parameter, for example, a base station is used as a transmit end and a receive end of the sensing signal, and a terminal or another object is used as a sensing target. In some embodiments, sensing based on a dual-station/multi-station mode, that is, transmission and receiving do not use a same address. A transmit end transmits a sensing signal, and another receive end receives and analyzes the sensing signal to extract a sensing parameter, for example, a base station 1 is used as a sensing signal transmit end, and a terminal or a base station 2 is used as a sensing signal receive end. Similarly, a transmit end that performs sensing in a single-station or multi-station mode may also be a terminal.

A communication system needs to jointly send a modulation symbol that carries information and a pilot symbol that is used for channel estimation, and focuses on decoding performance. A channel estimation algorithm of the communication system only needs to estimate a composite channel that has finite unknown parameters, and generally an optimization objective is to improve a throughput and transmission reliability. Performance indicators that are concerned are usually spectrum efficiency, a channel capacity, a Signal Noise Ratio (SNR)/signal to Signal to Interference plus Noise Ratio (SINR), a Bit Error Rate (BER)/Block Error Ratio (BLER)/a Symbol Error Rate (SER), and the like. However, an information carrying problem is not considered in a signal sending process of a sensing system. Generally, an optimized or unmodulated transmit signal is used, and a change, that is, a response feature, that is brought by a sensing target to a transmit signal is focused. Generally, an optimization target is to improve parameter estimation precision. A performance measurement indicator may be a fuzzy function, a Cramer-Rao lower bound, a root mean square error, mutual information, a rate distortion function, a radar estimation rate, a Welch lower bound, and some indicators associated with a sensing scenario and a requirement.

A sensing signal processing method provided in the embodiments of this application are described in detail below by using some embodiments and application scenarios thereof with reference to the accompanying drawings.

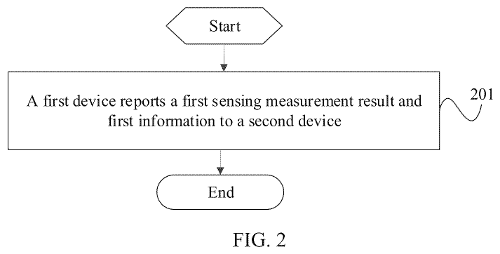

As shown in FIG. 2, an embodiment of this application provides a sensing information processing method, including:

Step 201: A first device reports a first sensing measurement result and first information to a second device.

The first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

The first sensing measurement result is a result obtained by the first device by performing sensing measurement.

In some embodiments, the first device is a base station or a terminal, the second device is a core network device, a base station, or a terminal. For example, the first device is a terminal, and the second device is a base station. For another example, the first device is a terminal and/or a base station, and the second device is a sensing network function or a sensing network element of a core network.

The first sensing indicator is an indicator for measuring sensing performance.

In this embodiment of this application, the second device sends sensing information, and the first device receives a sensing signal, and may obtain at least one sensing measurement result based on the sensing signal, obtain the first sensing measurement result based on the at least one sensing measurement result, and report, to the second device, the first sensing measurement result and at least one of the first sensing indicator or the first sensing resource indication information associated with the first sensing measurement result, so that the second device adjusts, based on the at least one of the first sensing indicator or the first sensing resource indication information, resource configuration information for subsequently sending the sensing signal. For example, if sensing indicators indicating a frequency domain location 1 and a frequency domain location 2 in the first sensing indicator meet a sensing requirement, a frequency domain location configuration used by the second device to subsequently send the sensing signal is the frequency domain location 1 and the frequency domain location 2, thereby effectively improving sensing performance.

In the sensing information processing method in this embodiment of this application, the first device reports the first sensing measurement result and the first information to the second device, where the first information includes at least one of the first sensing indicator or the first sensing resource indication information; and the second device adjusts, based on the at least one of the first sensing indicator or the first sensing resource indication information, resource configuration information used for subsequently sending a sensing signal, thereby effectively improving sensing performance.

In some embodiments, the first sensing indicator includes at least one of the following:
sensing accuracy or a sensing error;
sensing resolution;
a sensing range;
a sensing delay;
a detection probability;
a false alarm probability;
a quantity of targets detected at the same time;
a wireless measurement result of a sensing signal;
a signal-to-clutter ratio of a sensing signal;
a signal sidelobe feature (a ratio of a main lobe to a sidelobe of a signal) of a sensing signal;
a peak-to-average ratio of a sensing signal;
a variance of sensing measurement results;
a standard deviation of sensing measurement results; or information about a ratio of a first sensing signal component to a second sensing signal component, where the first sensing signal component is an amplitude corresponding to a sample point that meets a first condition or a square of the amplitude.

In some embodiments, the radio signal measurement result includes at least one of the following:
an SNR;
Reference Signal Received Power (RSRP) of a sensing signal;
Received Signal Strength Indication (RSSI) of a sensing signal; or
Reference Signal Received Quality (RSRQ).

In some embodiments, the first condition includes at least one of the following:
at least one sample point whose amplitude is the largest or whose amplitude exceeds a preset threshold in frequency domain channel responses of a received sensing signal, a sample point corresponding to at least one predetermined subcarrier SC, or a sample point corresponding to at least one predetermined physical resource block PRB, where the predetermined subcarrier or the predetermined PRB is agreed upon by the first device and the second device in advance, or is indicated by the second device, and the predetermined subcarrier and the predetermined PRB are respectively associated with a sensing requirement and a sensing service;
at least one sample point whose amplitude is the largest or whose amplitude exceeds a preset threshold in an inverse Fourier transform result of frequency domain channel responses of a received sensing signal;
at least one sample point whose amplitude is the largest or whose amplitude exceeds a preset threshold in a Fourier transform result of first time domain data; or
at least one sample point whose amplitude is the largest or whose amplitude exceeds a preset threshold in a delay Doppler domain result.

In some embodiments, the second sensing signal component includes:
an amplitude corresponding to a target sample point, a square sum of the amplitude corresponding to the target sample point, a mean of the amplitude corresponding to the target sample point, or a square mean of the amplitude corresponding to the target sample point; where
the target sample point includes at least one of the following:
a first sample point, where the first sample point is all sample point values of a frequency domain channel response of a received sensing signal;
a second sample point, where the second sample point is a sample point in the first sample point except a sample point corresponding to a first sensing signal component;
a third sample point, where the third sample point is all sample points in an inverse Fourier transform result of a frequency domain channel response of a received sensing signal;
a fourth sample point, where the fourth sample point is a sample point in the third sample point except a sample point corresponding to a first sensing signal component;
a fifth sample point, where the fifth sample point is all sample points in a Fourier transform result of first time domain data; or
a sixth sample point, where the sixth sample point is a sample point in the fifth sample point except a sample point corresponding to a first sensing signal component.

In some embodiments, the first time domain data is frequency domain channel responses (such as a frequency domain channel response corresponding to a subcarrier (SC), a resource element (RE), or a physical resource block (PRB)) corresponding to preset frequency resources of sensing signals received at different sampling times in a time domain observation range, or is an amplitude of the frequency domain channel response corresponding to the preset frequency resource or a square of the amplitude, or is a phase, I-channel data, or Q-channel data of the preset frequency resource or data obtained based on a first operation result of the I-channel data and the Q-channel data.

The time domain observation range is associated with a sensing requirement. The first device may determine the time domain observation range based on the sensing requirement. The time domain observation range may be determined according to an instruction of the second device.

In some embodiments, a first operation corresponding to the first operation result is I*cos (theta)+Q*sin (theta), where I represents I-channel data, Q represents Q-channel data, and theta is an angular value.

In some embodiments, the frequency domain channel response of the sensing signal includes a frequency domain channel response corresponding to at least one transmit/receive antenna combination.

In an embodiment of this application, in a multi-antenna (MIMO) scenario, the received frequency domain channel response of the sensing signal may be a frequency domain channel response corresponding to a transmit/receive antenna combination (for example, an antenna 1 performs transmitting and the antenna 1 performs receiving, or an antenna 1 performs transmitting and an antenna 2 performs receiving), or may be a combination of frequency domain channel responses corresponding to at least two transmit/receive antenna combinations, for example, a quotient or conjugate multiplication of frequency domain channel responses corresponding to two transmit/receive antenna combinations.

In some embodiments, before the first device reports the first sensing measurement result and the first information to the second device, the method further includes:
determining at least one sensing measurement result based on at least one of a sensing indicator or a sensing requirement; or
determining the first sensing measurement result based on the at least one sensing measurement result.

In some embodiments, the determining the first sensing measurement result based on the at least one sensing measurement result includes:
performing combination processing on at least two sensing measurement results to obtain the first sensing measurement result.

In an embodiment of this application, the first sensing measurement result used for reporting may be directly selected from all sensing measurement results. For example, the foregoing first sensing measurement is one or more sensing measurement results selected from all the sensing measurement results in a corresponding sequence of sensing indicators, and the selected sensing measurement results may be sensing measurement results corresponding to different time domain, frequency domain, spatial domain, angular domain, code domain, delay domain, Doppler domain, and antenna domain resource locations. For another example, in sensing results corresponding to a plurality of frequency domain locations (or SCs or REs or PRBs), a ratio of target sensing signal components (that is, the foregoing first sensing signal component) corresponding to a frequency domain location 1 and a frequency domain location 2 to another sensing signal component (that is, the foregoing second sensing signal component) is greater than a ratio of a target sensing signal component corresponding to another frequency domain location to another sensing signal component, and in this case, it is determined that the sensing measurement results corresponding to the frequency domain location 1 and the frequency domain location 2 are the first sensing measurement results, and a ratio of a target sensing signal component corresponding to the frequency domain location 1 and the frequency domain location 2 to another sensing signal component is the first sensing indicator. For another example, a sensing indicator in a sensing requirement specifies a threshold of a ratio of a target sensing signal component to another sensing signal component. In sensing results corresponding to a plurality of frequency domain locations (or SCs, or REs, or PRBs), a ratio of target sensing signal components corresponding to the frequency domain location 1 and the frequency domain location 2 to another sensing signal component exceeds the threshold. In this case, it is determined that sensing measurement results corresponding to the frequency domain location 1 and the frequency domain location 2 are the first sensing measurement result, and a ratio of target sensing signal components corresponding to the frequency domain location 1 and the frequency domain location 2 to another sensing signal component is the first sensing indicator.

The first sensing measurement result may also be obtained by selecting at least two sensing measurement results from all sensing measurement results and combining the at least two sensing measurement results. To be specific, a plurality of sensing measurement results (which may be sensing measurement results corresponding to different time domain, frequency domain, spatial domain, angular domain, code domain, delay domain, Doppler domain, and antenna domain resource locations) selected from all the sensing measurement results in a sequence of corresponding sensing indicators are directly summed up or weighted summed up to obtain sensing measurement results, where weighting factors for weighted combining are associated with the first sensing indicator. In some embodiments, before the combination, operations such as phase alignment or phase offset may be further included. For example, in sensing measurement results corresponding to a plurality of frequency domain locations (or SCs or REs or PRBs), if a ratio of target sensing signal components corresponding to a frequency domain location 1 and a frequency domain location 2 to another sensing signal component is greater than a ratio of a target sensing signal component corresponding to another frequency domain location to another sensing signal component, it is determined that a sum of sensing measurement results corresponding to the frequency domain location 1 and the frequency domain location 2 is the first sensing measurement result, or that a sensing measurement result corresponding to the frequency domain location 1 is multiplied by a weighting factor 1+a sensing measurement result corresponding to the frequency domain location 2 by a weighting factor 2 are the first sensing measurement result, where the weighting factor 1 may be a ratio R1 of a target sensing signal component corresponding to the frequency domain location 1 to another sensing signal component, and the weighting factor 2 may be a ratio R2 of a target sensing signal component corresponding to the frequency domain location 2 to another sensing signal component; or the weighting factor 1 is R1/(R1+R2), and the weighting factor 2 is R2/(R1+R2). R1+R2 or R1*R2 is used as the first sensing indicator, or (the target sensing signal component corresponding to the frequency domain location 1+the target sensing signal component corresponding to the frequency domain location 2)/(another sensing signal component corresponding to the frequency domain location 1+another sensing signal component corresponding to the frequency domain location 2) is used as the first sensing indicator.

In some embodiments, the sensing measurement result is a sensing measurement result obtained by the first device through calculation based on the received sensing signal, and is corresponding to a sensing measurement quantity determined based on a sensing requirement (the sensing measurement quantity may be determined based on a sensing requirement of the first device, or may be determined based on a sensing requirement of the second device and sent to the first device). The sensing measurement quantity includes at least one of the following:
original channel information;
signal strength information;
spectrum information;
multi-path information;
angle information;
difference information of signals corresponding to different antennas;
target parameter information determined based on the original channel information; or
the first time domain data or a Fourier transform (FFT) result of the first time domain data or an autocorrelation result of the first time domain data (a definition of the first time domain data is the same as that above).

The original channel information includes at least one of the following:
a channel matrix H; or
channel state information (CSI), such as an amplitude of a frequency domain channel response/a square sum/a phase of the amplitude, or an I-channel and Q-channel signal feature of a frequency domain channel response, such as an amplitude of an I-channel and Q-channel signal/a square of the amplitude.

The signal strength information includes at least one of the following:
RSRP; or
RSRI.

The spectrum information includes at least one of the following:
a channel power delay profile (PDP);
a Doppler power spectrum; or
a power azimuth spectrum (PAS).

The multi-path information includes at least one of the following:
power of each path (including at least a first path, a Line of Sight (LOS) path, a first-order reflection path, and a multi-order reflection path) in a multi-path channel;
a delay of each path in the multi-path channel; or
an angle of each path in the multi-path channel.

The difference information of signals corresponding to different antennas includes at least one of the following:
a quotient or conjugate multiplication of frequency domain channel responses of a first antenna and a second antenna;
an amplitude ratio or an amplitude difference of received signals of the first antenna and the second antenna;
a phase difference between the first antenna and the second antenna signal; or
a delay difference between the first antenna and the second antenna signal.

The target parameter information determined based on the original channel information includes at least one of the following:
Doppler spread;
Doppler frequency shift;
maximum delay spread;
angle spread;
coherent bandwidth; or
coherence time.

The angle information includes at least one of the following:
an angle of arrival; or
an angle of departure.

The angle information includes angle information on a UE side, angle information on a base station side, and angle information of a reflection point.

In some embodiments, the first resource indication information is used to indicate at least one of the following:
time domain resource information corresponding to the first sensing measurement result, such as absolute time, or a frame number/half-frame number, a timeslot number, or a symbol index;
frequency domain resource information corresponding to the first sensing measurement result, such as a frequency point or an SC index/PRB index;
spatial domain resource information or angular domain resource information corresponding to the first sensing measurement result, such as an angle value or a beam index;
code domain resource information corresponding to the first sensing measurement result, such as index information of a used sequence;
delay domain resource information corresponding to the first sensing measurement result;
Doppler domain resource information corresponding to the first sensing measurement result; or
antenna domain resource information corresponding to the first sensing measurement result, such as a corresponding transmit antenna index and a corresponding receive antenna index, or an index corresponding to a transmit/receive antenna combination.

In some embodiments, that the first device reports the first sensing measurement result and the first information to the second device includes:
reporting, by the first device, the first sensing measurement result and the first information to the second device in a target reporting manner; where
the target reporting manner includes at least one of the following:
an immediate reporting manner, where the immediate reporting manner is a manner in which reporting is performed after a sensing signal is received and the first sensing measurement result is obtained through calculation based on the sensing signal, that is, each time a sensing signal is received and reported after calculation, and in this case, a reporting period is the same as a sending period of the sensing signal;
a triggering reporting manner, where the triggering reporting manner is a manner of performing reporting in a case that a first triggering condition is met; or
a cumulative reporting manner, where the cumulative reporting manner is a manner of performing reporting after N calculation processes are completed, and each calculation process is receiving a sensing signal and obtaining the first sensing measurement result through calculation based on the sensing signal, where N is a positive integer greater than 2, that is, the sensing signal is received for a plurality of times and reported after calculation, and periodic reporting may be performed, that is, after the sensing signal is received every X times and calculated, the sensing signal is reported.

In some embodiments, the target reporting manner is indicated by the second device. The second device may further indicate a reporting period, a reporting time point, and a trigger reporting flag (when the reporting manner is triggering reporting), to instruct the first device to report the first sensing measurement result and/or the first sensing indicator and/or the first sensing resource indication information after the current sensing measurement is completed.

In some embodiments, the first triggering condition includes at least one of the following:
reporting indication information is received, for example, reporting is performed based on triggering reporting information of the second device, where the triggering reporting information may be included in the first sensing indication information, and may be separately sent by the second device; or
a calculated sensing measurement result is greater than a preset threshold, for example, the first device determines a threshold for a sensing measurement result obtained after performing an operation on the sensing signal, and reports the sensing measurement result to the second device after the sensing measurement result exceeds a preset threshold (which may be specified by the second device).

In some embodiments, that the first device reports the first sensing measurement result and the first information to the second device includes:
receiving, by the first device, first sensing indication information sent by the second device, where the first sensing indication information is used to assist the first device in determining at least one of the first sensing measurement result or the first information; and
reporting, by the first device, the first sensing measurement result and the first information to the second device according to the first sensing indication information.

In some embodiments, the first sensing indication information includes at least one of the following:
a sensing requirement, where the sensing requirement includes a sensing indicator and a corresponding condition that the sensing indicator needs to meet, for example, a minimum threshold of a ratio of a target sensing signal component to another sensing signal component, or a variation range of a variance of a sensing measurement result;
a sensing measurement quantity (corresponding to the sensing measurement result), used to instruct the first device to obtain a corresponding sensing measurement result through calculation based on the received sensing signal;
a first observation range used when a sensing measurement result or a sensing indicator is calculated;
indication information indicating resource location information corresponding to the first sensing measurement result, where the resource location information includes at least one of a time domain resource location, a frequency domain resource location, a spatial domain resource location, an angular domain resource location, a code domain resource location, a delay domain resource location, a Doppler domain resource location, and an antenna domain resource location; for example: a frequency domain location 1 (or an SC 1 or an RE 1 or a PRB 1), where in this case, after calculating a sensing measurement quantity, the first device directly uses a sensing measurement result corresponding to the frequency domain location 1 as the first sensing measurement result; or a transmit antenna 1 and a receive antenna 1, where in this case, the first device directly uses a sensing measurement result corresponding to a transmit/receive antenna combination 1 (the transmit antenna 1 and the receive antenna 1) as the first sensing measurement result; or
a manner of combining sensing measurement results, where the combining manner includes at least directly summing up, weighted summing up, calculating a quotient (dot division, that is, division by elements, for example, the sensing measurement results are two groups of vectors, and dot division is to divide corresponding elements in the two groups of elements), conjugate multiplication, and calculating a difference; for example, an indicated combining manner is directly summing up, and sensing measurement results corresponding to a plurality of frequency domain locations are obtained by the first device through calculation, and in this case, the first device sums up the sensing measurement results of the plurality of frequency domain locations as the first sensing measurement result; for another example, an indicated combining manner is calculating a quotient (dot division), and the second device obtains frequency domain channel responses corresponding to an antenna combination 1 (a transmit antenna 1 and a receive antenna 1) and an antenna combination 2 (a transmit antenna 1 and a receive antenna 2), and in this case, the first device uses a quotient of the frequency domain channel responses of the two groups of antenna combinations as the first sensing measurement result.

In some embodiments, the first observation range includes at least one of the following:
a time domain observation range;
a frequency domain observation range;
a spatial domain observation range or an angular domain observation range;
a code domain observation range;
a delay domain observation range;
a Doppler domain observation range; or an antenna domain observation range.

A form of the first sensing range may be an index range determined according to a pre-agreed rule, for example, an n1^{th} frame to an n2^{th} frame, or a sample point n1 to a sample point n2 after FFT/Inverse Fast Fourier Transform (IFFT) is performed on a fixed quantity of points, or may be a range represented by an actual physical unit, for example, f1 to f2 Hz, t1 to t2 s, or {transmit antenna tx1, transmit antenna tx2, receive antenna rx1, receive antenna rx2}.

In the sensing information processing method in this embodiment of this application, the first device reports the first sensing measurement result and the first information to the second device, where the first information includes at least one of the first sensing indicator or the first sensing resource indication information; and the second device adjusts, based on the at least one of the first sensing indicator or the first sensing resource indication information, resource configuration information used for subsequently sending a sensing signal, thereby effectively improving sensing performance.

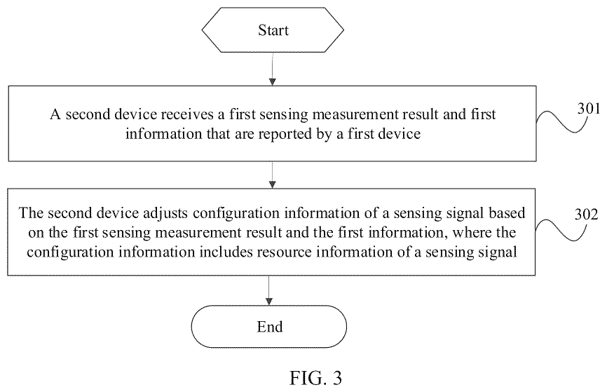

As shown in FIG. 3, an embodiment of this application further provides a sensing information processing method, including:
Step 301: A second device receives a first sensing measurement result and first information that are reported by a first device.
Step 302: The second device adjusts configuration information of a sensing signal based on the first sensing measurement result and the first information, where the configuration information includes resource information of a sensing signal.

The first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

The first information and the first sensing measurement result have been described in detail in the foregoing method embodiment on a first device side. Details are not described herein again.

For example, if the first sensing indicator indicates that a sensing indicator of a first target sensing resource meets a sensing requirement, the first target sensing resource is adjusted to resource information of a sensing signal, that is, the sensing signal is subsequently sent on the first target sensing resource.

For another example, if the first sensing resource indication information is a second target sensing resource (such as a PRB 1) for a plurality of consecutive times, or a second target sensing resource appears most frequently in the first sensing resource indication information for a plurality of consecutive times, a configuration for sending the sensing signal is adjusted to sending the sensing signal on the second target sensing resource.

In some embodiments, the first sensing resource indication information is used to indicate at least one of the following:
time domain resource information corresponding to the first sensing measurement result;
frequency domain resource information corresponding to the first sensing measurement result;
spatial domain resource information or angular domain resource information corresponding to the first sensing measurement result;
code domain resource information corresponding to the first sensing measurement result;
delay domain resource information corresponding to the first sensing measurement result;
Doppler domain resource information corresponding to the first sensing measurement result; or
antenna domain resource information corresponding to the first sensing measurement result.

In some embodiments, before the second device receives the first sensing measurement result and the first information that are reported by the first device, the method further includes:
sending, by the second device, first sensing indication information, where the first sensing indication information is used to assist the first device in determining at least one of the first sensing measurement result or the first information.

In some embodiments, the first sensing indication information includes at least one of the following:
a sensing requirement;
a sensing measurement quantity;
a first observation range used when a sensing measurement result or a sensing indicator is calculated;
indication information indicating resource location information corresponding to the first sensing measurement result; or
a manner of combining sensing measurement results.

In some embodiments, the first observation range includes at least one of the following:
a time domain observation range;
a frequency domain observation range;
a spatial domain observation range or an angular domain observation range;
a code domain observation range;
a delay domain observation range;
a Doppler domain observation range; or
an antenna domain observation range.

The first sensing indication information has been described in detail in the foregoing method embodiment on a first device side. Details are not described herein again.

The configuration information includes at least one of the following:
time domain, frequency domain, spatial domain, angular domain, code domain, delay domain, Doppler domain, or antenna domain resource locations of the sensing signal.

For example, if sensing indicators of a frequency domain location 1 and a frequency domain location 2 in the first sensing indicator reported by the first device meet a sensing requirement, a frequency domain configuration for sending a sensing signal next time is to send the sensing signal at the frequency domain location 1 and the frequency domain location 2. For another example, if sensing indicators of an antenna combination 1 (a transmit antenna 1 and a receive antenna 1) and an antenna combination 2 (a transmit antenna 1 and a receive antenna 2) in the first sensing indicator reported by the first device meet a sensing requirement, an antenna domain configuration for sending a sensing signal next time is to send a sensing signal on the transmit antenna 1.

According to the method in this embodiment of this application, the second device can adjust, based on the first sensing indicator and/or the first sensing resource indication information reported by the first device, resource configuration information for subsequently sending a sensing signal, thereby effectively improving sensing performance.

It should be noted that, in this embodiment of this application, in a process of measuring a sensing signal, the sensing signal may be sent or received in the following manners:

Manner 1: A base station A sends a sensing signal, and a base station B receives the sensing signal.

In this manner, the base station A is used as the second device, and the base station B is used as the first device; or a core network is used as the second device, and a base station A/B is used as the first device.

Manner 2: A base station sends a sensing signal, and UE receives the sensing signal.

In this manner, the base station is used as the second device, and the UE is used as the first device; or a core network is used as the second device, and the base station/UE is used as the first device.

Manner 3: A base station performs transmitting and receiving.

In this manner, a core network is used as the second device, and the base station is used as the first device.

Manner 4: UE performs transmitting and receiving.

In this manner, the base station is used as the second device, and the UE is used as the first device; or a core network is used as the second device, and the UE is used as the first device.

Manner 5: UE performs transmitting, and a base station performs receiving.

In this manner, a core network is used as the second device, and the base station is used as the first device.

Manner 6: UE A performs transmitting, and UE B performs receiving.

In this manner, the UE A is used as the second device, and the UE B is used as the first device; or an access base station of the UE A/B is used as the second device, and the UE A/B is used as the first device; or a core network is used as the second device, and the UE A/B is used as the first device; or a core network is used as the second device, and an access base station of the UE A/B is used as the first device.

In this embodiment of this application, a sensing signal may be sent by a plurality of devices, and the sensing signal may be received by a plurality of devices. The base station may be a TRP, an Access Point (AP), a relay, a Reconfigurable Intelligence Surface (RIS), or the like.

A sensing service in this embodiment of this application includes but is not limited to the following services:
object feature detection: Information that can reflect an attribute or a status of a target object may be at least one of the following: a location of the target object, a speed of the target object, an acceleration of the target object, a material of the target object, a shape of the target object, a type of the target object, a Radar Cross Section (RCS) of the target object, a polarization scattering feature, or the like;
event detection: Information related to a target event is information that can be detected/sensed when the target event occurs, and may be: falling down detection, intrusion detection, quantity statistics, indoor positioning, gesture recognition, lip language recognition, gait recognition, expression recognition, breath monitoring, heart rate monitoring, or the like; and
environment detection: humidity, brightness, temperature, humidity, atmospheric pressure, air quality, weather conditions, terrain, construction/vegetation distribution, population statistics, population density, vehicle density, and the like.

Breath detection is used as an example below to describe the sensing information processing method in this application in detail.

Embodiment 1: UE calculates a sensing indicator and selects to report a sensing measurement result.

A sensing requirement is breath detection, and a sensing measurement execution manner is: a base station sends a sensing signal, and UE receives the sensing signal and performs breath detection sensing correlation calculation to obtain a first sensing measurement result that needs to be reported to the base station.

(1) The base station sends a sensing signal based on a sensing requirement and/or a sensing signal configuration, where the sensing requirement and/or the sensing signal configuration may be from a network function or a network element (such as a sensing network function/sensing network element) of a core network.

(2) The base station sends first sensing indication information to UE, to assist the UE in determining a first sensing measurement result and/or a first sensing indicator that need to be reported, where the first sensing indication information may be determined by the base station based on the sensing requirement and/or the sensing signal configuration, or may be from the network function or the network element (such as the sensing network function/sensing network element) of the core network.

In some embodiments, the first sensing indication information is indication information related to breath detection signal processing. For specific content, refer to descriptions in a subsequent processing procedure.

(3) The UE receives a sensing signal from the base station, and obtains a frequency domain channel response H through channel estimation, such as least square (LS) channel estimation (that is, H=Y./X, where Y is a frequency domain form of a received sensing signal, and X is a frequency domain form of a local sensing signal) or minimum mean square error (MMSE) channel estimation, where Y./X represents division of elements corresponding to Y and X.

(4) The UE further processes H according to the received first sensing indication information, including:

based on an antenna domain combination manner indicated in the first sensing indication information, a quotient is calculated from H corresponding to a first antenna combination and a second antenna combination to obtain H_ratio. Assuming that there are a plurality of antenna combinations, and therefore, a plurality of H_ratios are obtained. For example, in a case of one transmit antenna and four receive antennas, there are a total of four antenna combinations, and a total of six H_ratios are obtained, which are respectively as follows:

H_ratio1=H_tx1_rx1./H_tx1_rx2;

H_ratio2=H_tx1_rx1./H_tx1_rx3;

H_ratio3=H_tx1_rx1./H_tx1_rx4;

H_ratio4=H_tx1_rx2./H_tx1_rx3;

H_ratio5=H_tx1_rx2./H_tx1_rx4; and

H_ratio6=H_tx1_rx3./H_tx1_rx4; where
H_tx1_rx1 represents a frequency domain channel response H corresponding to a transmit/receive antenna combination: a transmit antenna 1 and a receive antenna 1, and so on.

Assuming that there are a plurality of SCs or PRBs, and in this case, H_ratio is calculated for each SC or PRB.

A time domain format used by the base station to send a sensing signal to the UE corresponds to a time domain sampling period/sampling frequency of breath detection sensing data on a UE side. For example, if a period of sending the sensing signal is every 20 ms, the time domain sampling period of the breath detection sensing data on the UE side is 20 ms, and the sampling frequency is 50 Hz. The time domain format used by the base station to send the sensing signal is determined by the base station based on a sensing requirement, or is determined by a network function or a network element (such as a sensing network function/sensing network element) of a core network based on the sensing requirement. In principle, the Nyquist sampling criterion in sensing time domain needs to be met, that is, the time domain sampling frequency needs to be greater than or equal to 2 times of a maximum breath frequency.

(5) The base station notifies the UE of a time domain observation window T1 (that is, the time domain observation range mentioned above) by using the first sensing indication information. For each breath detection data time domain sample point in the window T1, there are correspondingly H_ratios of a plurality of SCs or PRBs and a plurality of antenna combinations. An H_ratio corresponding to a specific SC or PRB and a specific antenna combination may be used to obtain a plurality of H_ratios that reflect a breath rule in the window T1. Further, the first time domain data may be obtained through calculation. A calculation method may be as follows:

A frequency domain channel response quotient H_ratio in the window T1 is used as the first time domain data.

An amplitude of the frequency domain channel response quotient H_ratio in the window T1 is used as the first time domain data.

A phase of the frequency domain channel response quotient H_ratio in the window T1 is used as the first time domain data;
I-channel data of the frequency domain channel response quotient H_ratio in the window T1 is used as the first time domain data.

Q-channel data of the frequency domain channel response quotient H_ratio in the window T1 is used as the first time domain data.

A result of a projection operation (the projection operation may be I*cos (theta)+Q*sin (theta), where theta is a specific angular value, different theta is corresponding to different projections, I represents I-channel data, and Q represents Q-channel data) of the I-channel data and the Q-channel data of the frequency domain channel response quotient H_ratio in the window T1 is used as the first time domain data.

In some embodiments, the foregoing method is performed on the H_ratio to obtain candidate first time domain data, and the candidate first time domain data is pre-processed to obtain the first time domain data. The preprocessing may be:
low-pass or band-pass filtering, such as using a Butterworth filter;
processing of removing an exception value, such as using Hampel filtering or setting an exception value threshold, where for example, all or some sample values in the time domain observation window T1 are taken to calculate a mean and a standard deviation, the exception value threshold is set to the average value ±t* the standard deviation, t is a real number factor, and a sample value point that exceeds the threshold is replaced with a previous sample value point or a next sample value point; and smoothing filtering processing, such as Savitzky-Golay filtering.

(6) After the first time domain data is obtained, a breath detection sensing indicator is determined based on first sensing indication information sent by the base station, and then the first time domain data that is used to calculate a to-be-reported first sensing measurement result is selected from first time domain data corresponding to different SCs or PRBs and/or different antenna combinations and/or different projections. A method for determining the breath detection sensing indicator may be as follows:

Method 1: FFT transform is performed on the first time domain data, and a ratio of a target sensing signal component to another sensing signal component is calculated, which is defined as BNR (Breath to Noise Ratio). The target sensing component is an amplitude corresponding to a sample point with a largest amplitude in an FFT result of the first time domain data or a square of the amplitude. It may be considered that the sample point with the largest amplitude is a sample point corresponding to a breath frequency.

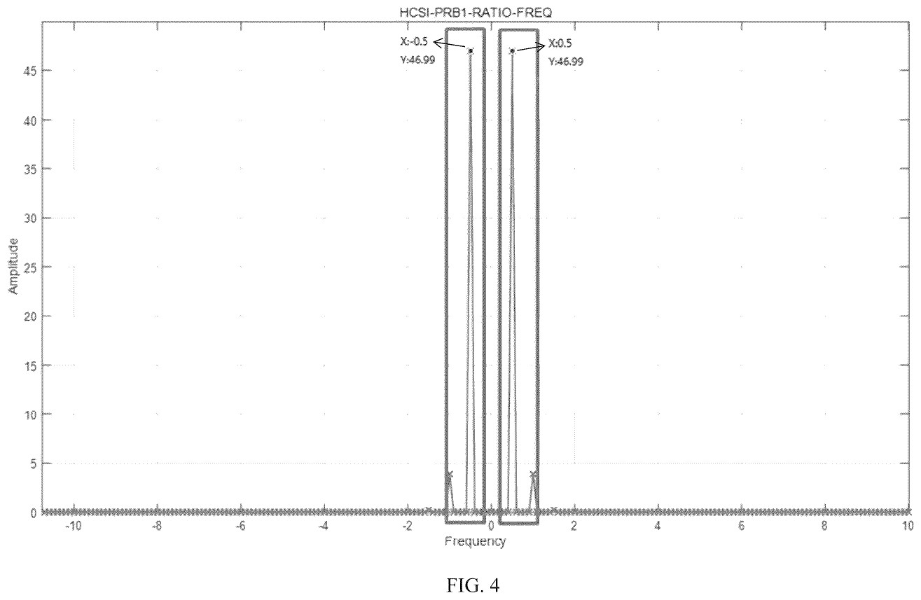

In some embodiments, based on a frequency domain observation window F1 in the first sensing indication information sent by the base station, a sample point with a largest amplitude is searched in a range of the window F1 as a sample point corresponding to the breath frequency, where F1 is determined by the base station based on a breath rate range in a breath detection sensing service, or is determined by a network function or a network element (such as a sensing network function/sensing network element) of a core network based on a sensing requirement, for example, F1 refers to a frequency range of f1 to f2 Hz and −f2 to −f1 Hz, that is, an actual frequency range, as shown in FIG. 4. Two parallel rectangular frames represent the frequency domain observation window F1. If it is found that corresponding frequencies of the sample points with the largest amplitude are 0.5 Hz and −0.5 Hz in F1, amplitudes corresponding to the two sample points 0.5 Hz and −0.5 Hz and/or a square sum of the amplitudes are used as the target sensing component, and a sum of amplitudes corresponding to all sample points or a square sum of the amplitudes, or a mean or a square mean of amplitudes corresponding to all sample points, or a sum of amplitudes corresponding to all or some sample values except the two sample points 0.5 Hz and −0.5 Hz or a square sum of the amplitudes, or a mean or a square mean of amplitudes corresponding to all or some sample values except the two sample points 0.5 Hz and −0.5 Hz is used as the another sensing component, to calculate BNR=Target sensing component/Another sensing component.

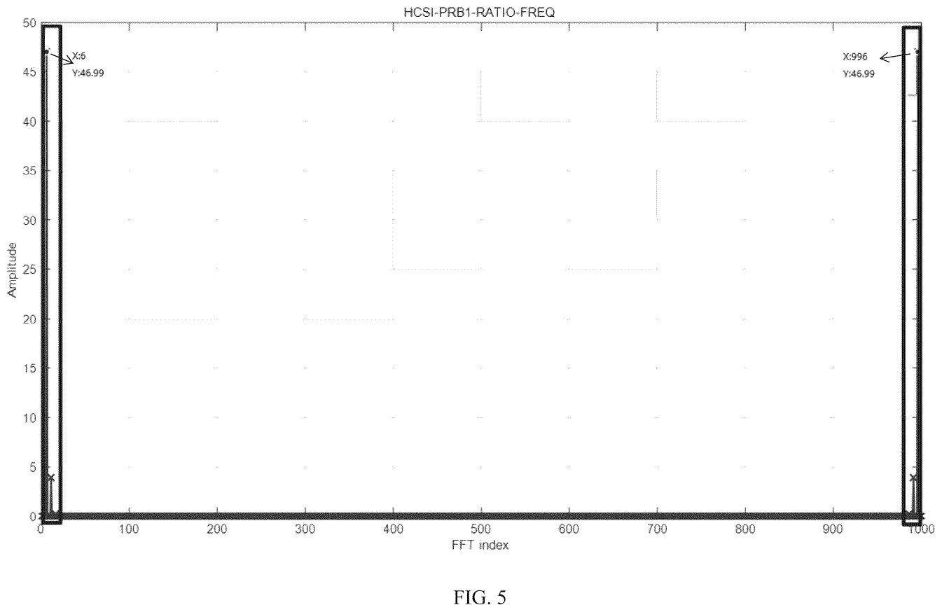

In some embodiments, it is assumed that the time domain observation window T1 includes N sample points, that is, a quantity of FFT points is N. A time domain sampling frequency Fs=1/Ts may be obtained based on a time domain sampling period Ts and the quantity of FFT points, and a frequency domain interval deltaf=Fs/N of adjacent sample points after the FFT is obtained. The foregoing actual frequency range is converted into a sample index of an FFT result, and a conversion manner is idx1=f (f1/deltaf), idx2=f (f2/deltaf), idx3=f (Fs−f2)/deltaf), and idx4=f((Fs−f1)/deltaf), where an f ( ) operation indicates rounding up or rounding down or rounding off, and F1 indicates sample point indexes idx1 to idx2 and idx3 to idx4 after the FFT, as shown in FIG. 5. Two rectangular frames on the left and the right represent the frequency domain observation window F1. If FFT result indexes corresponding to a sample point with a largest amplitude found in F1 are 6 and 996 (in this case, N=1000, Fs=100 Hz, and indexes 6 and 996 are respectively corresponding to 0.5 Hz and −0.5 Hz), a square sum of amplitudes corresponding to the two sample points corresponding to the index 6 and the index 996 are used as the target sensing component, and the another sensing signal component and a BNR calculation method are the same as those above.

Method 2: A variance or a standard deviation of the first time domain data is calculated, and the variance or the standard deviation is use as the breath detection sensing indicator.

(7) After the breath detection sensing indicator (that is, the foregoing BNR or variance/standard deviation) is obtained, first time domain data corresponding to an SC or PRB and/or an antenna combination and/or an IQ projection (if any) with a largest BNR or variance/standard deviation is used to calculate the to-be-reported first sensing measurement result, and is referred to as second time domain data.

In some embodiments, a sensing indicator threshold is determined according to the first sensing indication information sent by the base station, and first time domain data whose BNR or variance/standard deviation exceeds the threshold is further selected from first time domain data corresponding to different SCs or PRBs and/or different antenna combinations and/or different projections to calculate the to-be-reported first sensing measurement result, and is referred to as second time domain data.

A method for calculating the to-be-reported first sensing measurement result based on the second time domain data may be as follows:

Method 1: All second time domain data or some second time domain data is directly used as the first sensing measurement result. The some second time domain data may be second time domain data corresponding to a segment of time domain observation sub-window in the time domain observation window T1, or some second time domain data obtained after second time domain data in the time domain observation window T1 is extracted. An extraction rule may be carried in a sensing indication message of the base station, or may be implemented by the UE. However, a sampling frequency corresponding to an extracted part of second time domain data needs to be greater than or equal to twice a maximum breath frequency.

Method 2: All or some results obtained after an FFT operation of the second time domain data is used as the first sensing measurement result, and some results of the FFT operation may be results that are in all results obtained after the FFT operation and that are located in the frequency domain observation window F1.

Method 3: All or some results of an autocorrelation operation of the second time domain data are used as the first sensing measurement result. The some results of the autocorrelation operation are the first X results of all results of the autocorrelation operation, and X is at least greater than or equal to a sampling frequency of the second time domain data divided by a minimum possible breath frequency.

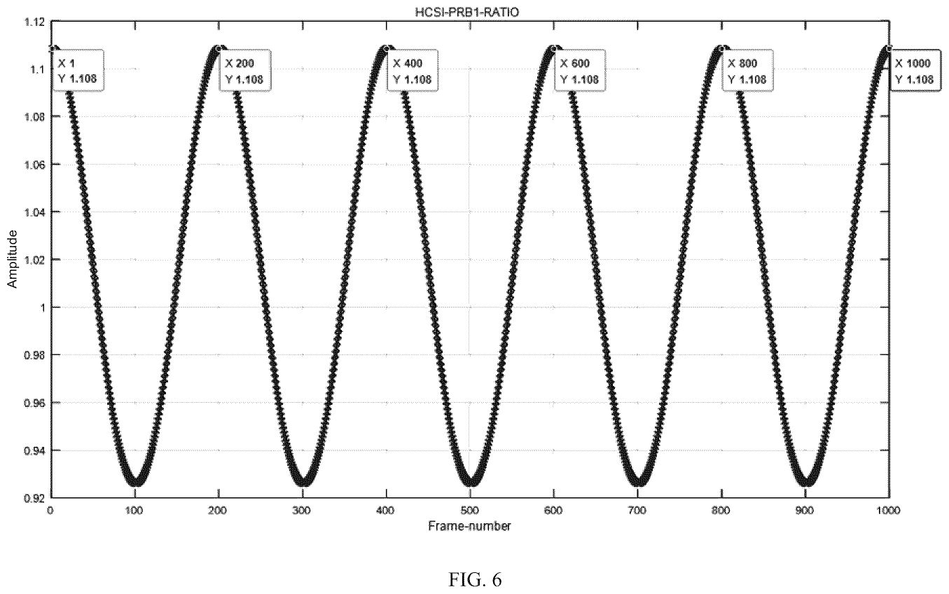

Method 4: Peak information of the second time domain data is used as the first sensing measurement result. As shown in FIG. 6, the second time domain data is an amplitude of a frequency domain channel response quotient H_ratio in a window T1 corresponding to an SC or PRB and/or an antenna combination and/or an IQ projection (if any) with a largest BNR or a largest variance/standard deviation, and sample points whose time domain indexes are 1, 200, 400, 600, 800, and 1000 are peak points, and a time domain index and/or a time domain amplitude of the peak point are reported as the first sensing measurement result.

In particular, if there are a plurality of pieces of second time domain data, the second time domain data may be first combined to obtain the first sensing measurement result through calculation in the foregoing manner, or a plurality of first sensing measurement results may be first obtained through calculation in the foregoing manner, and then the plurality of first sensing measurement results are combined to obtain the first sensing measurement result that is used for reporting. A combining manner may be directly summing up or weighted summing up. For example, there are two groups of second time domain data that are respectively second time domain data 1 corresponding to an antenna combination 1, an IQ projection 1, and an SC 1, and second time domain data 2 corresponding to an antenna combination 1, an IQ projection 1, and an SC 2, and sensing indicators are respectively BNR 1 and BNR 2. After the second time domain data 1+the second time domain data 2, all results or some results obtained after an FFT operation are used as the first sensing measurement result; or after the second time domain data 1*BNR1+the second time domain data 2*BNR2, all or some results obtained after an FFT operation are used as the first sensing measurement result; or all or some results are obtained by performing an FFT operation on the second time domain data 1 to obtain a first sensing measurement result 1, all or some results are obtained by performing an FFT operation on the second time domain data 2 to obtain the first sensing measurement result 2, and the first sensing measurement result 1*BNR1+the first sensing measurement result 2*BNR2 is used as the to-be-reported first sensing measurement result.

(8) An SC or PRB and/or an antenna combination corresponding to the first sensing measurement result is used as the first sensing resource indication information.

(9) After receiving the first sensing measurement result and/or the first sensing indicator and/or the first sensing resource indication information that are reported by the UE, the base station adjusts a related configuration for sending a sensing signal. For example, if the first sensing resource indication information is a PRB 1 and a PRB 2, an antenna combination 1 (a transmit antenna 1 and a receive antenna 1), and an antenna combination 2 (a transmit antenna 1 and a receive antenna 2), the base station adjusts the configuration for sending a sensing signal to sending the sensing signal on the PRB 1, the PRB 2, and the antenna 1.

The base station may immediately adjust the configuration for sending the sensing signal. In other words, after receiving the first sensing measurement result and/or the first sensing indicator and/or the first sensing resource indication information that are reported by the UE, the base station adjusts a related configuration before a next sensing signal is sent, or may perform adjustment after accumulation. For example, after the base station receives the first sensing measurement result and/or the first sensing indicator and/or the first sensing resource indication information that are reported by the UE for a plurality of times, the base station adjusts, after statistic counting, the related configuration for sending the sensing signal. For example, the first sensing resource indication information is the PRB 1 for a plurality of consecutive times, or the PRB 1 appears for a maximum quantity of times in a plurality of pieces of first sensing resource indication information, the base station adjusts the configuration for sending the sensing signal to sending the sensing signal on the PRB 1.

Embodiment 2: The base station calculates a sensing indicator and instructs the UE to report a sensing measurement result.

A sensing requirement is breath detection, and a sensing measurement execution manner is: the base station sends a sensing signal, and the UE receives the sensing signal but does not perform breath detection related calculation. In this case, the first sensing measurement result reported by the UE is a primary measurement result such as an initial channel frequency domain response H. The base station determines a first sensing indicator and a first sensing resource based on the breath detection sensing requirement and/or the primary measurement quantity reported by the UE, and instructs the UE to report the first sensing measurement result.

(1) The base station sends a sensing signal based on a sensing requirement and/or a sensing signal configuration, where the sensing requirement and/or the sensing signal configuration may be from a network function or a network element (such as a sensing network function/sensing network element) of a core network.

(2) The UE receives the sensing signal sent by the base station, and obtains a frequency domain channel response H through channel estimation, such as least square (LS) channel estimation (that is, H=Y./X, where Y is a frequency domain form of a received sensing signal, and X is a frequency domain form of a local sensing signal) or minimum mean square error (MMSE) channel estimation.

(3) The UE reports the foregoing H as an initial first sensing measurement result to the base station.

(4) The base station receives the first sensing measurement result H reported by the UE, and further processes H to obtain a first sensing indicator and/or a first sensing resource indication, where processing on H and calculation of the first sensing indicator and/or the first sensing resource indication are the same as those in Embodiment 1.

(5) The base station sends first sensing indication information to the UE based on the first sensing indicator and/or the first sensing resource indication, to instruct the UE to determine a first sensing measurement result that needs to be reported or updated. For example, if the first sensing resource indication information is a PRB 1 and a PRB 2, an antenna combination 1 (a transmit antenna 1 and a receive antenna 1), and an antenna combination 2 (a transmit antenna 1 and a receive antenna 2), the base station instructs, by using the first sensing indication information, the UE to use a frequency domain channel response H2 corresponding to the transmit antenna 1 on the PRB 1 and the PRB 2 as the first sensing measurement result and report the first sensing measurement result to the base station, that is, the UE reports the first sensing measurement result according to the sensing indication information.

(6) The UE periodically reports the initial first sensing measurement result H to the base station, and the base station further processes H and updates the first sensing indicator and/or the first sensing resource indication, and then indicates a new reporting rule of the UE by using the sensing indication information, that is, adjusts the reported first sensing measurement result.

In some embodiments, the base station obtains a first sensing indicator through calculation based on a first sensing measurement result H2 reported by the UE, compares the first sensing indicator with a sensing indicator threshold, and when the threshold requirement is not met, the base station instructs, by using the sensing indication information, the UE to report the initial first sensing measurement result H. The base station further processes H and updates the first sensing indicator and/or the first sensing resource indication, and then indicates a new reporting rule of the UE by using the sensing indication information, that is, adjusts the reported first sensing measurement result.

(7) The base station adjusts, based on the first sensing indicator and/or the first sensing resource indication information that are obtained through calculation, a related configuration for sending the sensing signal. A specific adjustment manner is the same as that in Embodiment 1.

Embodiment 3: A core network calculates a sensing indicator and instructs a base station and/or UE to report a sensing measurement result.

A sensing requirement is breath detection, and a sensing measurement execution manner is: the base station sends a sensing signal, the UE receives the sensing signal, or the base station sends and receives a sensing signal, or base stations send and receive a sensing signal, or the UE sends a sensing signal and the base station receives the sensing signal, or the UE sends and receives a sensing signal, or UEs send and receive a sensing signal.

(10) The base station and/or the UE perform a breath detection measurement procedure, and perform specific breath detection sensing correlation calculation to obtain a first sensing measurement result that needs to be reported to the core network.

(20) The base station and/or the UE perform no breathing detection-related calculation. In this case, a first sensing measurement result reported by the base station and/or the UE is a primary measurement result such as an initial channel frequency domain response H, and the core network determines the first sensing indicator and a first sensing resource based on the breath detection sensing requirement and/or the received primary measurement result, and instructs the base station and/or the UE to report the first sensing measurement result.

For the foregoing (10):

The network function or the network element (such as the sensing network function/sensing network element) of the core network sends the sensing requirement and/or the sensing signal configuration to the base station and/or the UE, and the base station and/or the UE send/receive a sensing signal based on the sensing requirement and/or the sensing signal configuration.

The network function or the network element (such as the sensing network function/sensing network element) of the core network sends sensing indication information to the base station and/or the UE, to assist the base station and/or the UE in determining a sensing measurement result and/or a sensing indicator that need to be reported. The sensing indication information may be determined by the network function or the network element (such as the sensing network function/sensing network element) of the core network based on the sensing requirement and/or the sensing signal configuration.

In some embodiments, the sensing indication information is indication information related to breath detection signal processing. Specific content is the same as that in Embodiment 1.

The base station and/or the UE obtain a frequency domain channel response H through calculation based on the received sensing signal, and further process H to obtain the first sensing measurement result and/or the first sensing indicator and/or the first sensing resource indication, and send the first sensing measurement result and/or the first sensing indicator and/or the first sensing resource indication to the core network. A specific processing manner is the same as that in Embodiment 1.

After receiving the first sensing measurement result and/or the first sensing indicator and/or the first sensing resource indication information reported by the base station and/or the UE, the core network adjusts a related configuration for sending the sensing signal and sends the related configuration to the base station and/or the UE. A specific adjustment manner is the same as that in Embodiment 1.

For the foregoing (20):
The network function or the network element (such as the sensing network function/sensing network element) of the core network sends the sensing requirement and/or the sensing signal configuration to the base station and/or the UE, and the base station and/or the UE send/receive a sensing signal based on the sensing requirement and/or the sensing signal configuration,
The network function or the network element (such as the sensing network function/sensing network element) of the core network sends first sensing indication information to the base station and/or the UE, to assist the base station and/or the UE in determining a sensing measurement result and/or a sensing indicator that need to be reported, where the first sensing indication information may be determined by the network function or the network element (such as the sensing network function/sensing network element) of the core network based on the sensing requirement and/or the sensing signal configuration.

In some embodiments, the sensing indication information is indication information related to breath detection signal processing. Specific content is the same as that in Embodiment 1.

The base station and/or the UE obtain a frequency domain channel response H through calculation based on the received sensing signal, and the base station and/or the UE report H as an initial first sensing measurement result to the core network.

The core network receives the first sensing measurement result H reported by the base station and/or the UE, and further processes H to obtain the first sensing indicator and/or the first sensing resource indication, where processing on H and calculation of the first sensing indicator and/or the first sensing resource indication are the same as those in Embodiment 1.

The core network sends the first sensing indication information to the base station and/or the UE based on the first sensing indicator and/or the first sensing resource indication, and a function of the first sensing indication information is the same as that in Embodiment 2.

A manner in which the base station and/or the UE report the initial first sensing measurement result H to the core network is the same as that in Embodiment 2.

The core network adjusts, based on the first sensing indicator and/or the first sensing resource indication information that are obtained through calculation, a related configuration used by the base station and/or the UE to send a sensing signal, and sends the configuration to the base station and/or the UE. A specific adjustment manner is the same as that in Embodiment 1.

In this embodiment of this application, message exchange such as that the network function or the network element (such as the sensing network function/sensing network element) of the core network sends the sensing requirement and/or the sensing signal configuration and/or the sensing indication information to the base station and/or the UE, and receives the first sensing measurement result and/or the like reported by the base station and/or the UE may be implemented by using an Access and Mobility Management Function (AMF) or by using a User Plane Function (UPF), or may directly interact with the base station and/or the UE.

It should be noted that the sensing information processing method provided in the embodiments of this application may be performed by a sensing information processing apparatus, or a control module that is in the sensing information processing apparatus and that is configured to perform the sensing information processing method. In the embodiments of this application, that the sensing information processing apparatus performs the sensing information processing method is used as an example to describe the sensing information processing apparatus provided in the embodiments of this application.

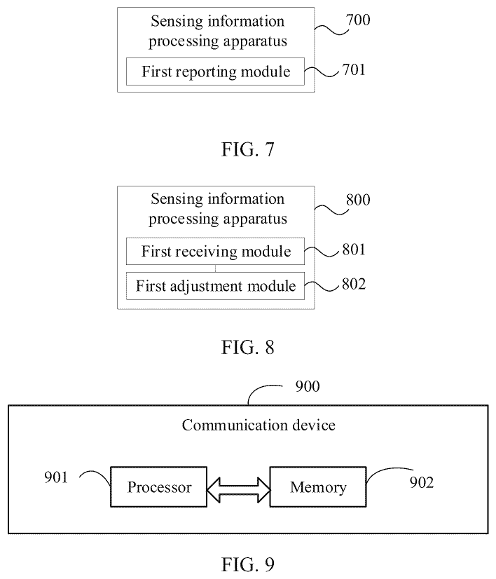

As shown in FIG. 7, an embodiment of this application further provides a sensing information processing apparatus 700, including:
a first reporting module 701, configured to report a first sensing measurement result and first information to a second device; where
the first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

The apparatus in this embodiment of this application further includes a determining apparatus, configured to determine the first sensing measurement result and the first information.

In some embodiments, the first sensing indicator includes at least one of the following:
sensing accuracy or a sensing error;
sensing resolution;
a sensing range;
a sensing delay;
a detection probability;
a false alarm probability;
a quantity of targets detected at the same time;
a radio signal measurement result of a sensing signal;
a signal-to-clutter ratio;
a signal sidelobe feature;
a peak-to-average ratio;
a variance;
a standard deviation; or
information about a ratio of a first sensing signal component to a second sensing signal component, where the first sensing signal component is an amplitude corresponding to a sample point that meets a first condition or a square of the amplitude.

In some embodiments, the radio signal measurement result includes at least one of the following:
a signal-to-noise ratio (SNR);
reference signal received power (RSRP) of a sensing signal;
received signal strength indication (RSSI) of a sensing signal; or
reference signal received quality (RSRQ) of a sensing signal.

In some embodiments, the first condition includes at least one of the following:
at least one sample point whose amplitude is the largest or whose amplitude exceeds a preset threshold in frequency domain channel responses of a received sensing signal, a sample point corresponding to at least one predetermined subcarrier (SC), or a sample point corresponding to at least one predetermined physical resource block (PRB);
at least one sample point whose amplitude is the largest or whose amplitude exceeds a preset threshold in an inverse Fourier transform result of frequency domain channel responses of a received sensing signal;
at least one sample point whose amplitude is the largest or whose amplitude exceeds a preset threshold in a Fourier transform result of first time domain data; or
at least one sample point whose amplitude is the largest or whose amplitude exceeds a preset threshold in a delay Doppler domain result.

In some embodiments, the second sensing signal component includes:
an amplitude corresponding to a target sample point, a square sum of the amplitude corresponding to the target sample point, a mean of the amplitude corresponding to the target sample point, or a square mean of the amplitude corresponding to the target sample point; where
the target sample point includes at least one of the following:
a first sample point, where the first sample point is all sample point values of a frequency domain channel response of a received sensing signal;
a second sample point, where the second sample point is a sample point in the first sample point except a sample point corresponding to a first sensing signal component;
a third sample point, where the third sample point is all sample points in an inverse Fourier transform result of a frequency domain channel response of a received sensing signal;
a fourth sample point, where the fourth sample point is a sample point in the third sample point except a sample point corresponding to a first sensing signal component;
a fifth sample point, where the fifth sample point is all sample points in a Fourier transform result of first time domain data; or
a sixth sample point, where the sixth sample point is a sample point in the fifth sample point except a sample point corresponding to a first sensing signal component.

In some embodiments, the first time domain data is frequency domain channel responses corresponding to preset frequency resources of sensing signals received at different sampling times in a time domain observation range, or is an amplitude of the frequency domain channel response corresponding to the preset frequency resource or a square of the amplitude, or is a phase, I-channel data, or Q-channel data of the preset frequency resource or data obtained based on a first operation result of the I-channel data and the Q-channel data.

In some embodiments, the frequency domain channel response of the sensing signal includes a frequency domain channel response corresponding to at least one transmit/receive antenna combination.

In some embodiments, the apparatus in this embodiment of this application further includes:
a first determining module, configured to: before the first reporting module reports the first sensing measurement result and the first information to the second device, determine at least one sensing measurement result based on at least one of a sensing indicator or a sensing requirement; and
a second determining module, configured to determine the first sensing measurement result based on the at least one sensing measurement result.

In some embodiments, the second determining module is configured to perform combination processing on at least two sensing measurement results to obtain the first sensing measurement result.

In some embodiments, the first resource indication information is used to indicate at least one of the following:
time domain resource information corresponding to the first sensing measurement result;
frequency domain resource information corresponding to the first sensing measurement result;
spatial domain resource information or angular domain resource information corresponding to the first sensing measurement result;
code domain resource information corresponding to the first sensing measurement result;
delay domain resource information corresponding to the first sensing measurement result;
Doppler domain resource information corresponding to the first sensing measurement result; or
antenna domain resource information corresponding to the first sensing measurement result.

In some embodiments, the first reporting module is configured to report the first sensing measurement result and the first information to the second device in a target reporting manner; where
the target reporting manner includes at least one of the following:
an immediate reporting manner, where the immediate reporting manner is a manner in which reporting is performed after a sensing signal is received and the first sensing measurement result is obtained through calculation based on the sensing signal;
a triggering reporting manner, where the triggering reporting manner is a manner of performing reporting in a case that a first triggering condition is met; or
a cumulative reporting manner, where the cumulative reporting manner is a manner of performing reporting after N calculation processes are completed, and each calculation process is receiving a sensing signal and obtaining the first sensing measurement result through calculation based on the sensing signal, where N is a positive integer greater than 2.

In some embodiments, the first triggering condition includes at least one of the following:
reporting indication information is received; or
a calculated sensing measurement result is greater than a preset threshold.

In some embodiments, the first reporting module includes:
a first receiving sub-module, configured to receive first sensing indication information sent by the second device, where the first sensing indication information is used to assist the first device in determining at least one of the first sensing measurement result or the first information; and
a first reporting sub-module, configured to report the first sensing measurement result and the first information to the second device according to the first sensing indication information.

In some embodiments, the first sensing indication information includes at least one of the following:
a sensing requirement;
a sensing measurement quantity;
a first observation range used when a sensing measurement result or a sensing indicator is calculated;
indication information indicating resource location information corresponding to the first sensing measurement result; or
a manner of combining sensing measurement results.

In some embodiments, the first observation range includes at least one of the following:
a time domain observation range;
a frequency domain observation range;
a spatial domain observation range or an angular domain observation range;
a code domain observation range;
a delay domain observation range;
a Doppler domain observation range; or
an antenna domain observation range.

According to the apparatus in this embodiment of this application, a first sensing measurement result and first information are reported to a second device, where the first information includes at least one of a first sensing indicator or first sensing resource indication information; and the second device adjusts, based on the at least one of the first sensing indicator or the first sensing resource indication information, resource configuration information for subsequently sending a sensing signal, thereby effectively improving sensing performance.

As shown in FIG. 8, an embodiment of this application further provides a sensing information processing apparatus 800, including:
a first receiving module 801, configured to receive a first sensing measurement result and first information that are reported by a first device; and
a first adjustment module 802, configured to adjust configuration information of a sensing signal based on the first sensing measurement result and the first information, where the configuration information includes resource information of the sensing signal; and
the first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

In some embodiments, the first sensing resource indication information is used to indicate at least one of the following:
time domain resource information corresponding to the first sensing measurement result;
frequency domain resource information corresponding to the first sensing measurement result;
spatial domain resource information or angular domain resource information corresponding to the first sensing measurement result;
code domain resource information corresponding to the first sensing measurement result;
delay domain resource information corresponding to the first sensing measurement result;
Doppler domain resource information corresponding to the first sensing measurement result; or
antenna domain resource information corresponding to the first sensing measurement result.

The apparatus in this embodiment of this application further includes:
a first sending module, configured to send first sensing indication information before the first receiving module receives the first sensing measurement result and the first information that are reported by the first device, where the first sensing indication information is used to assist the first device in determining at least one of the first sensing measurement result or the first information.

In some embodiments, the first sensing indication information includes at least one of the following:
a sensing requirement;
a sensing measurement quantity;
a first observation range used when a sensing measurement result or a sensing indicator is calculated;
indication information indicating resource location information corresponding to the first sensing measurement result; or
a manner of combining sensing measurement results.

In some embodiments, the first observation range includes at least one of the following:
a time domain observation range;
a frequency domain observation range;
a spatial domain observation range or an angular domain observation range;
a code domain observation range;
a delay domain observation range;
a Doppler domain observation range; or
an antenna domain observation range.

According to the apparatus in this embodiment of this application, a second device can adjust, based on at least one of a first sensing indicator or first sensing resource indication information, resource configuration information for subsequently sending a sensing signal, thereby effectively improving sensing performance.

As shown in FIG. 9, an embodiment of this application further provides a communication device 900, including a processor 901, a memory 902, and a program or an instruction that is stored in the memory 902 and that can run on the processor 901. When the program or the instruction is executed by the processor 901, the processes of the foregoing embodiments of the sensing information processing method can be implemented, and a same technical effect can be achieved. To avoid repetition, details are not described herein again.

An embodiment of this application further provides a communication device. The communication device may be the first device or the second device. The communication device includes a processor and a communication interface. When the communication device is the first device, the communication interface is configured to report a first sensing measurement result and first information to the second device, where the first information includes at least one of the following: a first sensing indicator, where the first sensing indicator is a sensing indicator associated with the first sensing measurement result; or first sensing resource indication information, where the first sensing resource indication information is used to indicate resource information corresponding to the first sensing measurement result.

When the communication device is the second device, the communication interface is configured to receive a first sensing measurement result and first information that are reported by a first device, and the processor is configured to adjust configuration information of a sensing signal based on the first sensing measurement result and the first information, where the first information includes at least one of the following: a first sensing indicator, where the first sensing indicator is a sensing indicator associated with the first sensing measurement result; or first sensing resource indication information, where the first sensing resource indication information is used to indicate resource information corresponding to the first sensing measurement result.

This communication device embodiment is corresponding to the foregoing device and method embodiments. Each implementation process and implementation of the foregoing method embodiments may be applicable to the communication device embodiment, and a same technical effect can be achieved.

The sensing information processing apparatus in this embodiment of this application may be an apparatus or an electronic device with an operating system, or may be a component, an integrated circuit, or a chip in a terminal. The apparatus or the electronic device may be a mobile terminal, or a non-mobile terminal. For example, the mobile terminal may include but is not limited to the foregoing listed types of the terminal 11. The non-mobile terminal may be a server, a Network Attached Storage (NAS), a personal computer (PC), a television (TV), a teller machine, or a self-service machine. This is not specifically limited in this embodiment of this application.

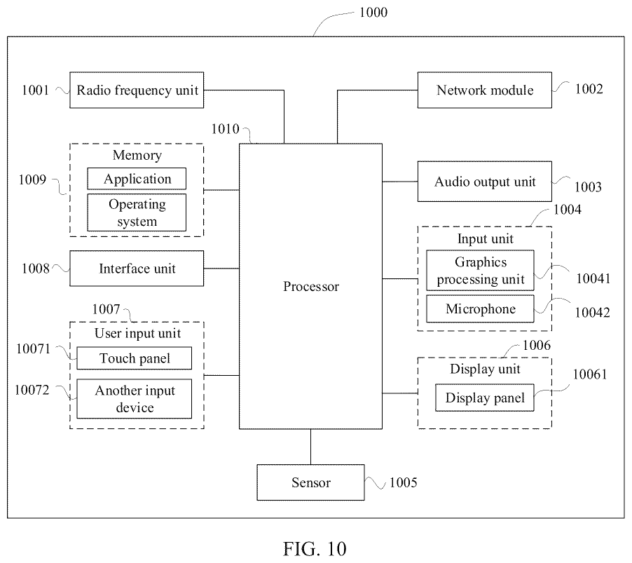

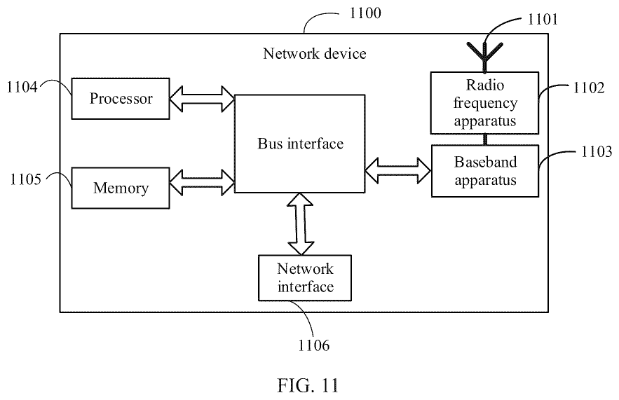

FIG. 10 is a schematic diagram of a hardware structure of a communication device for implementing the embodiments of this application. The communication device may be a terminal. A terminal 1000 includes but is not limited to at least some components in a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein again.

In this embodiment of this application, the radio frequency unit 1001 receives downlink data from a network side device and then sends the downlink data to the processor 1010 for processing; and sends uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a program or instruction storage area and a data storage area. The program or instruction storage area may store an operating system, an application or an instruction required by at least one function (for example, a sound playing function or an image playing function), and the like. In addition, the memory 1009 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 1010 may include one or more processing units. In some embodiments, an application processor and a modem processor may be integrated into the processor 1010. The application processor mainly processes an operating system, a user interface, an application, an instruction, or the like. The modem processor mainly processes wireless communication, for example, a baseband processor. It may be understood that, the modem processor may not be integrated into the processor 1010.

In an embodiment of this application, the radio frequency unit 1001 is configured to report a first sensing measurement result and first information to a second device; where
the first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

In some embodiments, the first sensing indicator includes at least one of the following:
sensing accuracy or a sensing error;
sensing resolution;
a sensing range;
a sensing delay;
a detection probability;
a false alarm probability;
a quantity of targets detected at the same time;
a radio signal measurement result of a sensing signal;
a signal-to-clutter ratio of a sensing signal;
a signal sidelobe feature of a sensing signal;
a peak-to-average ratio of a sensing signal;
a variance of sensing measurement results;
a standard deviation of sensing measurement results; or
information about a ratio of a first sensing signal component to a second sensing signal component, where the first sensing signal component is an amplitude corresponding to a sample point that meets a first condition or a square of the amplitude.

In some embodiments, the radio signal measurement result includes at least one of the following:
a signal-to-noise ratio (SNR);
reference signal received power (RSRP) of a sensing signal;
received signal strength indication (RSSI) of a sensing signal; or
reference signal received quality (RSRQ) of a sensing signal.

In some embodiments, the first condition includes at least one of the following:
at least one sample point whose amplitude is the largest or whose amplitude exceeds a preset threshold in frequency domain channel responses of a received sensing signal, a sample point corresponding to at least one predetermined subcarrier (SC), or a sample point corresponding to at least one predetermined physical resource block (PRB);
at least one sample point whose amplitude is the largest or whose amplitude exceeds a preset threshold in an inverse Fourier transform result of frequency domain channel responses of a received sensing signal;
at least one sample point whose amplitude is the largest or whose amplitude exceeds a preset threshold in a Fourier transform result of first time domain data; and
at least one sample point whose amplitude is the largest or whose amplitude exceeds a preset threshold in a delay Doppler domain result.

In some embodiments, the second sensing signal component includes:
an amplitude corresponding to a target sample point, a square sum of the amplitude corresponding to the target sample point, a mean of the amplitude corresponding to the target sample point, or a square mean of the amplitude corresponding to the target sample point; where the target sample point includes at least one of the following:
a first sample point, where the first sample point is all sample point values of a frequency domain channel response of a received sensing signal;
a second sample point, where the second sample point is a sample point in the first sample point except a sample point corresponding to a first sensing signal component;
a third sample point, where the third sample point is all sample points in an inverse Fourier transform result of a frequency domain channel response of a received sensing signal;
a fourth sample point, where the fourth sample point is a sample point in the third sample point except a sample point corresponding to a first sensing signal component;
a fifth sample point, where the fifth sample point is all sample points in a Fourier transform result of first time domain data; or
a sixth sample point, where the sixth sample point is a sample point in the fifth sample point except a sample point corresponding to a first sensing signal component.

In some embodiments, the first time domain data is frequency domain channel responses corresponding to preset frequency resources of sensing signals received at different sampling times in a time domain observation range, or is an amplitude of the frequency domain channel response corresponding to the preset frequency resource or a square of the amplitude, or is a phase, I-channel data, or Q-channel data of the preset frequency resource or data obtained based on a first operation result of the I-channel data and the Q-channel data.

In some embodiments, the frequency domain channel response of the sensing signal includes a frequency domain channel response corresponding to at least one transmit/receive antenna combination.

In some embodiments, before the radio frequency unit 1001 reports the first sensing measurement result and the first information to the second device, the processor 1010 is further configured to: determine at least one sensing measurement result based on at least one of a sensing indicator or a sensing requirement; and determine the first sensing measurement result based on the at least one sensing measurement result.

In some embodiments, the processor 1010 is further configured to perform combination processing on at least two sensing measurement results to obtain the first sensing measurement result.

In some embodiments, the first resource indication information is used to indicate at least one of the following:
time domain resource information corresponding to the first sensing measurement result;
frequency domain resource information corresponding to the first sensing measurement result;
spatial domain resource information or angular domain resource information corresponding to the first sensing measurement result;
code domain resource information corresponding to the first sensing measurement result;
delay domain resource information corresponding to the first sensing measurement result;
Doppler domain resource information corresponding to the first sensing measurement result; or
antenna domain resource information corresponding to the first sensing measurement result.

In some embodiments, the radio frequency unit 1001 is configured to report the first sensing measurement result and the first information to the second device in a target reporting manner; where
the target reporting manner includes at least one of the following:
an immediate reporting manner, where the immediate reporting manner is a manner in which reporting is performed after a sensing signal is received and the first sensing measurement result is obtained through calculation based on the sensing signal;
a triggering reporting manner, where the triggering reporting manner is a manner of performing reporting in a case that a first triggering condition is met; or
a cumulative reporting manner, where the cumulative reporting manner is a manner of performing reporting after N calculation processes are completed, and each calculation process is receiving a sensing signal and obtaining the first sensing measurement result through calculation based on the sensing signal, where N is a positive integer greater than 2.

In some embodiments, the first triggering condition includes at least one of the following:
reporting indication information is received; or
a calculated sensing measurement result is greater than a preset threshold.

In some embodiments, the radio frequency unit 1001 is configured to: receive first sensing indication information sent by the second device, where the first sensing indication information is used to assist the first device in determining at least one of the first sensing measurement result or the first information; and report the first sensing measurement result and the first information to the second device according to the first sensing indication information.

In some embodiments, the first sensing indication information includes at least one of the following:
a sensing requirement;
a sensing measurement quantity;
a first observation range used when a sensing measurement result or a sensing indicator is calculated;
indication information indicating resource location information corresponding to the first sensing measurement result; or
a manner of combining sensing measurement results.

In some embodiments, the first observation range includes at least one of the following:
a time domain observation range;
a frequency domain observation range;
a spatial domain observation range or an angular domain observation range;
a code domain observation range;
a delay domain observation range;
a Doppler domain observation range; or
an antenna domain observation range.

In another embodiment of this application, the radio frequency unit 1001 is configured to receive a first sensing measurement result and first information that are reported by a first device, and the processor 1010 is configured to adjust configuration information of a sensing signal based on the first sensing measurement result and the first information, where the configuration information includes resource information of the sensing signal; and
the first information includes at least one of the following:
a first sensing indicator, where the first sensing indicator is a sensing indicator associated with the first sensing measurement result; or
first sensing resource indication information, where the first sensing resource indication information is used to indicate resource information corresponding to the first sensing measurement result.

In some embodiments, the first sensing resource indication information is used to indicate at least one of the following:
time domain resource information corresponding to the first sensing measurement result;
frequency domain resource information corresponding to the first sensing measurement result;
spatial domain resource information or angular domain resource information corresponding to the first sensing measurement result;
code domain resource information corresponding to the first sensing measurement result;
delay domain resource information corresponding to the first sensing measurement result;
Doppler domain resource information corresponding to the first sensing measurement result; or
antenna domain resource information corresponding to the first sensing measurement result.

In some embodiments, the radio frequency unit 1001 is configured to send first sensing indication information, where the first sensing indication information is used to assist the first device in determining at least one of the first sensing measurement result or the first information.

In some embodiments, the first sensing indication information includes at least one of the following:
a sensing requirement;
a sensing measurement quantity;
a first observation range used when a sensing measurement result or a sensing indicator is calculated;
indication information indicating resource location information corresponding to the first sensing measurement result; or
a manner of combining sensing measurement results.

In some embodiments, the first observation range includes at least one of the following:
a time domain observation range;
a frequency domain observation range;
a spatial domain observation range or an angular domain observation range;
a code domain observation range;
a delay domain observation range;
a Doppler domain observation range; or
an antenna domain observation range.

In this embodiment of this application, a first sensing measurement result and first information are reported, where the first information includes at least one of a first sensing indicator or first sensing resource indication information, and a second device adjusts, based on the at least one of the first sensing indicator or the first sensing resource indication information, resource configuration information for subsequently sending a sensing signal, thereby effectively improving sensing performance.

An embodiment of this application further provides a network device. The network device is the first device or the second device. As shown in FIG. 11, a network device 1100 includes an antenna 1101, a radio frequency apparatus 1102, and a baseband apparatus 1103. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes information that needs to be sent, and sends processed information to the radio frequency apparatus 1102. The radio frequency apparatus 1102 processes the received information, and sends processed information by using the antenna 1101.

The frequency band processing apparatus may be located in the baseband apparatus 1103. The method performed by the first device in the foregoing embodiment may be implemented in the baseband apparatus 1103. The baseband apparatus 1103 includes a processor 1104 and a memory 1105.

The baseband apparatus 1103 may include, for example, at least one baseband board, where a plurality of chips are disposed on the baseband board. As shown in FIG. 11, one chip is, for example, the processor 1104, which is connected to the memory 1105, so as to invoke a program in the memory 1105 to perform operations of the first device shown in the foregoing method embodiment.

The baseband apparatus 1103 may further include a network interface 1106, configured to exchange information with the radio frequency apparatus 1102. For example, the interface is a common public radio interface (CPRI).

The communication device in this embodiment of the present application further includes an instruction or a program that is stored in the memory 1105 and that can run on the processor 1104. The processor 1104 invokes the instruction or the program in the memory 1105 to perform the method performed by the modules shown in FIG. 8, and a same technical effect is achieved. To avoid repetition, details are not described herein again.

An embodiment of this application further provides a readable storage medium. A program or an instruction is stored in the readable storage medium. When the program or the instruction is executed by a processor, processes of the foregoing embodiments of the sensing information processing method can be implemented, and a same technical effect can be achieved. To avoid repetition, details are not described herein again.

The processor is a processor in the terminal in the foregoing embodiment. The readable storage medium includes a computer-readable storage medium, such as a computer Read-Only Memory (ROM), a Random Access Memory (RAM), a magnetic disk, an optical disc, or the like.

An embodiment of this application further provides a chip. The chip includes a processor and a communication interface, the communication interface is coupled to the processor, and the processor is configured to run a program or an instruction to implement the processes of the foregoing embodiments of the sensing information processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program product, the computer program product is stored in a non-volatile storage medium, and the computer program product is executed by at least one processor to implement the processes of the foregoing embodiment of the sensing information processing method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be mobile phone, a computer, a server, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

1. A method for sensing information processing, comprising:
reporting, by a first device, a first sensing measurement result and first information to a second device,
wherein the first information comprises at least one of the following:
a first sensing indicator, wherein the first sensing indicator is a sensing indicator associated with the first sensing measurement result; or
first sensing resource indication information, wherein the first sensing resource indication information is used to indicate resource information corresponding to the first sensing measurement result.

2. The method according to claim 1, wherein the first sensing indicator comprises at least one of the following:
sensing accuracy or a sensing error;
sensing resolution;
a sensing range;
a sensing delay;
a detection probability;
a false alarm probability;
a quantity of targets detected at the same time;
a radio signal measurement result of a sensing signal;
a signal-to-clutter ratio of a sensing signal;
a signal sidelobe feature of a sensing signal;
a peak-to-average ratio of a sensing signal;
a variance of sensing measurement results;
a standard deviation of sensing measurement results; or
information about a ratio of a first sensing signal component to a second sensing signal component, wherein the first sensing signal component is an amplitude corresponding to a sample point that meets a first condition or a square of the amplitude.

3. The method according to claim 2, wherein the radio signal measurement result comprises at least one of the following:
a signal-to-noise ratio (SNR);
reference signal received power (RSRP);
received signal strength indication (RSSI); or
reference signal received quality (RSRQ).

4. The method according to claim 2, wherein the first condition comprises at least one of the following:
at least one sample point whose amplitude is the largest or whose amplitude exceeds a preset threshold in frequency domain channel responses of a received sensing signal, a sample point corresponding to at least one predetermined subcarrier (SC), or a sample point corresponding to at least one predetermined physical resource block (PRB);
at least one sample point whose amplitude is the largest or whose amplitude exceeds a preset threshold in an inverse Fourier transform result of frequency domain channel responses of a received sensing signal;
at least one sample point whose amplitude is the largest or whose amplitude exceeds a preset threshold in a Fourier transform result of first time domain data; or
at least one sample point whose amplitude is the largest or whose amplitude exceeds a preset threshold in a delay Doppler domain result.

5. The method according to claim 2, wherein the second sensing signal component comprises:
an amplitude corresponding to a target sample point, a square sum of the amplitude corresponding to the target sample point, a mean of the amplitude corresponding to the target sample point, or a square mean of the amplitude corresponding to the target sample point,
wherein the target sample point comprises at least one of the following:
a first sample point, wherein the first sample point is all sample point values of a frequency domain channel response of a received sensing signal;
a second sample point, wherein the second sample point is a sample point in the first sample point except a sample point corresponding to a first sensing signal component;
a third sample point, wherein the third sample point is all sample points in an inverse Fourier transform result of a frequency domain channel response of a received sensing signal;
a fourth sample point, wherein the fourth sample point is a sample point in the third sample point except a sample point corresponding to a first sensing signal component;
a fifth sample point, wherein the fifth sample point is all sample points in a Fourier transform result of first time domain data; or
a sixth sample point, wherein the sixth sample point is a sample point in the fifth sample point except a sample point corresponding to a first sensing signal component.

6. The method according to claim 4, wherein the first time domain data is frequency domain channel responses corresponding to preset frequency resources of sensing signals received at different sampling times in a time domain observation range, or is an amplitude of the frequency domain channel response corresponding to the preset frequency resource or a square of the amplitude, or is a phase, I-channel data, or Q-channel data of the preset frequency resource or data obtained based on a first operation result of the I-channel data and the Q-channel data.

7. The method according to claim 1, before the reporting, by a first device, a first sensing measurement result and first information to a second device, further comprising:
determining at least one sensing measurement result based on at least one of a sensing indicator or a sensing requirement; and
determining the first sensing measurement result based on the at least one sensing measurement result.

8. The method according to claim 7, wherein the determining the first sensing measurement result based on the at least one sensing measurement result comprises:
performing combination processing on at least two sensing measurement results to obtain the first sensing measurement result.

9. The method according to claim 1, wherein the first resource indication information is used to indicate at least one of the following:
time domain resource information corresponding to the first sensing measurement result;
frequency domain resource information corresponding to the first sensing measurement result;
spatial domain resource information or angular domain resource information corresponding to the first sensing measurement result;
code domain resource information corresponding to the first sensing measurement result;
delay domain resource information corresponding to the first sensing measurement result;
Doppler domain resource information corresponding to the first sensing measurement result; or
antenna domain resource information corresponding to the first sensing measurement result.

10. The method according to claim 1, wherein the reporting, by a first device, a first sensing measurement result and first information to a second device comprises:
reporting, by the first device, the first sensing measurement result and the first information to the second device in a target reporting manner,
wherein the target reporting manner comprises at least one of the following:
an immediate reporting manner, wherein the immediate reporting manner is a manner in which reporting is performed after a sensing signal is received and the first sensing measurement result is obtained through calculation based on the sensing signal;
a triggering reporting manner, wherein the triggering reporting manner is a manner of performing reporting when a first triggering condition is met; or
a cumulative reporting manner, wherein the cumulative reporting manner is a manner of performing reporting after N calculation processes are completed, and each calculation process is receiving a sensing signal and obtaining the first sensing measurement result through calculation based on the sensing signal, wherein N is a positive integer greater than 2.

11. The method according to claim 10, wherein the first triggering condition comprises at least one of the following:
reporting indication information is received; or
a calculated sensing measurement result is greater than a preset threshold.

12. The method according to claim 1, wherein the reporting, by a first device, a first sensing measurement result and first information to a second device comprises:
receiving, by the first device, first sensing indication information sent by the second device, wherein the first sensing indication information is used to assist the first device in determining at least one of the first sensing measurement result or the first information; and
reporting, by the first device, the first sensing measurement result and the first information to the second device according to the first sensing indication information.

13. The method according to claim 12, wherein the first sensing indication information comprises at least one of the following:
a sensing requirement;
a sensing measurement quantity;
a first observation range used when a sensing measurement result or a sensing indicator is calculated;
indication information indicating resource location information corresponding to the first sensing measurement result; or
a manner of combining sensing measurement results.

14. The method according to claim 13, wherein the first observation range comprises at least one of the following:
a time domain observation range;
a frequency domain observation range;
a spatial domain observation range or an angular domain observation range;
a code domain observation range;
a delay domain observation range;
a Doppler domain observation range; or
an antenna domain observation range.

15. A method for sensing information processing, comprising:
receiving, by a second device, a first sensing measurement result and first information that are reported by a first device; and
adjusting, by the second device, configuration information of a sensing signal based on the first sensing measurement result and the first information, wherein the configuration information comprises resource information of the sensing signal; and
the first information comprises at least one of the following:
a first sensing indicator, wherein the first sensing indicator is a sensing indicator associated with the first sensing measurement result; or
first sensing resource indication information, wherein the first sensing resource indication information is used to indicate resource information corresponding to the first sensing measurement result.

16. The method according to claim 15, before the receiving, by a second device, a first sensing measurement result and first information that are reported by a first device, further comprising:
sending, by the second device, first sensing indication information, wherein the first sensing indication information is used to assist the first device in determining at least one of the first sensing measurement result or the first information.

17. A communication device, wherein the communication device is a first device, comprising: a memory storing a computer program; and a processor coupled to the memory and configured to execute the computer program to perform operations comprising:
reporting, by the first device, a first sensing measurement result and first information to a second device,
wherein the first information comprises at least one of the following:
a first sensing indicator, wherein the first sensing indicator is a sensing indicator associated with the first sensing measurement result; or
first sensing resource indication information, wherein the first sensing resource indication information is used to indicate resource information corresponding to the first sensing measurement result.

18. The communication device according to claim 17, wherein the first sensing indicator comprises at least one of the following:
sensing accuracy or a sensing error;
sensing resolution;
a sensing range;
a sensing delay;
a detection probability;
a false alarm probability;
a quantity of targets detected at the same time;
a radio signal measurement result of a sensing signal;
a signal-to-clutter ratio of a sensing signal;
a signal sidelobe feature of a sensing signal;
a peak-to-average ratio of a sensing signal;
a variance of sensing measurement results;
a standard deviation of sensing measurement results; or
information about a ratio of a first sensing signal component to a second sensing signal component, wherein the first sensing signal component is an amplitude corresponding to a sample point that meets a first condition or a square of the amplitude.

19. The communication device according to claim 18, wherein the radio signal measurement result comprises at least one of the following:
a signal-to-noise ratio (SNR);
reference signal received power (RSRP);
received signal strength indication (RSSI); or
reference signal received quality (RSRQ).

20. A communication device, wherein the communication device is a second device, comprising: a memory storing a computer program; and a processor coupled to the memory and configured to execute the computer program to perform the method according to claim 15.
